(19) United States
(12) Patent Application Publication
(10) Pub. No.: US 2023/0192939 A1
(43) Pub. Date: Jun. 22, 2023

(54) Hydrophobically Modified Polyurethane Thickener And Process For Its Preparation

(71) Applicant: Clariant International Ltd., Muttenz (CH)

(72) Inventors: Lin NIU, Shanghai (CN); Chunyan WANG, Shanghai (CN)

(73) Assignee: Clariant International Ltd., Muttenz (CH)

(21) Appl. No.: 17/915,196

(22) PCT Filed: Mar. 31, 2020
(86) PCT No.: PCT/CN2020/082342

§ 371 Date: Sep. 28, 2022

(51) Int. Cl. C08G 18/42; C08G 18/48; C08G 18/75; C08G 18/24; C09D 7/43

(52) U.S. Cl. CPC C08G 18/4277; C08G 18/48; C08G 18/758; C08G 18/246; C09D 7/43

(57) ABSTRACT

The present invention relates to a thickener composition comprising a hydrophobically modified alkylene oxide polyurethane obtained by reacting a water-soluble polyalkylene glycol, a diisocyanate and a polyester end-capping agent which is a reaction product of a lactone compound and a monhydroxy compound. The present invention further relates to a process for the preparation of the hydrophobically modified alkylene oxide polyurethane.

### BACKGROUND OF THE INVENTION

### Field of the Invention

The present invention pertains to thickeners based on hydrophobically modified polyurethanes having a special structure, processes of preparing them, and their uses in waterborne coatings formulations.

### Description of Background Art

Rheology modifiers, commonly referred to as rheology thickeners, are vital additives used in coating composition to achieve a desired flow behavior. Apart from providing improved coating viscosity and stability, rheology thickeners also help optimize coating performance in sagging control, statin resistance and other application characteristics.

Rheology thickeners can come from both natural and synthetic sources. Synthetic thickeners used in waterborne industrial coatings are typically grouped into alkaline-swellable/soluble emulsions (ASE), hydrophobically modified alkali-swellable emulsions (HASE), and hydrophobically modified ethylene oxide urethane resins (HEUR). Among them, HEUR thickeners are usually preferred in performance, since they are water soluble at any pH and offer a wide range of rheological properties. Generally, known HEUR structures are able to provide high associative thickening effect in waterborne coating solutions, resulting in enhanced flow and levelling, high film build, and satisfactory brush/roller loading.

Nevertheless, for most commercially available HEURs used in waterborne coating, the same high associative force HEURs generate to bind pigment particles for thickening tends to overly decrease spacing between the pigment particles, resulting an undesired loss in tint strength and hiding properties of coating composition. Moreover, performance of many known HEURs was also found to have a high dependence of latex resin type used in architectural coatings.

It would therefore be advantageous to develop a new HEUR additive which, while maintaining an exceptional rheological thickening effect of known HEURs, features a minimized negative impact in coating tint strength and hiding properties, as well as an improved compatibility with various latex resins used in architectural coating.

### SUMMARY OF THE INVENTION

In a first aspect, the present invention provides a thickener composition comprising a hydrophobically modified alkylene oxide polyurethane obtainable by reacting (a) a polyester obtained by reacting a lactone compound with a monohydroxy compound of formula (I)

X—OH (I)

wherein X represents an aliphatic, cycloaliphatic or aromatic hydrocarbon group having at least 5 carbon atoms and optionally containing one —O— or —COO— group;

(b) a water-soluble polyalkylene glycol, and

(c) a diisocyanate.

In a second aspect, the present invention provides an end-capping agent for preparing a hydrophobically modified alkylene oxide polyurethane, wherein the end-capping agent is a polyester obtained by reacting a lactone compound with a monohydroxy compound of formula (I) via lactone ring-opening polymerization reaction

X—OH (I)

wherein X is as defined above.

In a third aspect, the present invention provides an end-capping agent for preparing a hydrophobically modified alkylene oxide polyurethane, wherein the end-capping agent is a polyester having the structure of formula (II)

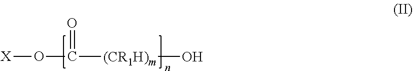

Wherein X is as defined above, each Ri is independently H or C1-C4 alkyl, m is an integer from 2 to 7 and preferably from 3 to 5, and n is an integer from 1 to 10 and preferably from 4 to 8.

In a fourth aspect, the present invention provides a hydrophobically modified alkylene oxide polyurethane having the following structure (III):

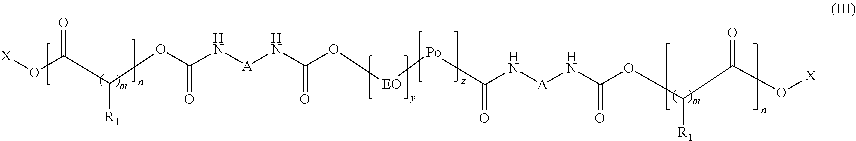

wherein X, R₁, m, and n are as defined above, EO and PO respectively designating ethylene oxide unit and propylene oxide unit, y is an integer from 40 to 250, z is an integer from 0 to 95 and less than y, and A represents a straight-chain or branched alkylene, arylene or aralkylene radical with 4 to 15 carbon atoms, each optionally substituted with one or more C1 to C4 alkyl group and/or one or more halogen atoms. As used herein, the term “ethylene oxide unit” refers to the group of —OCH₂CH₂—, and the term “propylene oxide unit” refers to the group of —OCH(CH₃)CH₂—.

### DETAILED DESCRIPTION OF THE INVENTION

In a first aspect, the present invention provides a thickener composition comprising a hydrophobically modified alkylene oxide polyurethane obtainable by reacting (a) an end-capping agent obtained by reacting a lactone compound with a monohydroxy compound of formula (I)

X—OH (I)

wherein X represents an aliphatic, cycloaliphatic or aromatic hydrocarbon group having at least 5 carbon atoms and optionally containing at least one —O— or —COO— group;

(b) a water-soluble polyalkylene glycol, and

(C) a diisocyanate.

The abovementioned rheology thickener composition can further contain water and optionally one or more organic solvents (S).

The solvents (S) are volatile organic solvents. Suitable examples thereof are low molecular weight alcohols, such as methanol, ethanol, n-propanol, i-propanol, n-butanol, i-butanol, sec-butanol, ethanediol, butanediol, glycerol, trimethylol propane.

Water-soluble polyalkylene glycols suitable for the present invention are alkylene oxide polymers including primary hydroxyl groups on both ends of their polymer chains, and as monomers alkylene oxides selected from a group of ethylene oxide, propylene oxide, butylene oxide and epichlorohydrin. Particularly, in order to ensure sufficient water solubility of the polyalkylene glycol, the content of ethylene oxide unit is preferably 40% by weight or higher, more preferably 60% by weight or higher, and most preferably 70% by weight to 100% by weight. “Water soluble” as used herein means a solubility in water at 20° C. of at least 1 g/L, preferably at least 10 g/L, more preferably at least 50 g/L.

Water-soluble polyalkylene glycols suitable for the present invention may be those with a number average molecular weight (Mn) of 1,500 to 50,000, more preferably 3,000 to 20,000, and most preferably 4,000 to 10,000 g/mol. The inventors found that the polyalkylene glycols characterized by the abovementioned preferred molecular weight ranges help obtain HEUR products with sufficient aqueous solution viscosity.

Preferred water-soluble polyalkylene glycols for the present invention are selected from polyethylene glycols, ethylene oxide/propylene oxide block copolymers, and ethylene oxide/propylene oxide/ethylene oxide block terpolymers.

In one preferred embodiment of the present invention, polyethylene glycol is used. An example of a particularly suitable polyethylene glycol for the present invention is Polyglykol 8000S (Mn of 8000 g/mol) from Clariant.

The diisocyanate used in the present invention has a general formula (V)

O═C═N-A-N═C═O (V)

wherein A represents a straight-chain or branched alkylene, arylene or aralkylene radical with 4 to 15 carbon atoms, each optionally substituted with one or more C1 to C4 alkyl group and/or one or more halogen atoms.

Examples of the suitable diisocyanates include, but not limited to, 1,4-tetramethylene diisocyanate, 1,6-hexamethylene diisocyanate, 2,2,4- and 2,4,4- trimethyl-1,6-diisocyanatohexane, 1,10-decamethylene diisocyanate, 4,4′-methylenebis(isocyanatocyclohexane), 1,2- and 1,4-cyclohexylene diisocyanate, isophorone diisocyanate, m- and p-phenylene diisocyanate, 2,6- and 2,4-toluene diisocyanate, xylene diisocyanate, 4-chloro-1,3-phenylene diisocyanate, 4,4′-biphenylene diisocyanate, 4,4′-methylene diphenylisocyanate, 1,5-naphthylene diisocyanate, and 1,5-tetrahydronaphthylene diisocyanate.

Accordingly, A may be selected from the group consisting of 1,4-tetramethylene, 1,6-hexamethylene, 2,2,4- and 2,4,4- trimethyl-1,6- hexamethylene, 1,10-decamethylene, 4,4′-methylenebis(cyclohexane), 1,2- and 1,4-cyclohexylene, isophorone, m- and p-phenylene, 2,6- and 2,4-toluene, xylene, 4-chloro-1,3-phenylene, 4,4′-biphenylene, 4,4′-methylene diphenyl, 1,5-naphthylene, and 1,5-tetrahydronaphthylene.

More preferred diisocyanates for the present invention include 1,6-hexamethylene diisocyanate (HDI), isophorone diisocyanate (IPDI), and 4,4′-methylenebis(isocyanatocyclohexane) (H₁₂-MDI), with 4,4′-methylenebis(isocyanatocyclohexane) (H₁₂-MDI) being particularly preferred.

Accordingly, A is preferably selected from a group consisting of 1,6-hexamethylene, isophorone, and 4,4′-methylenebis(cyclohexane), with 4,4′-methylenebis(cyclohexane) (H₁₂-MDI) being more preferred.

The amount of diisocyanate in the reaction mixture can vary from about 1% to about 70%, preferably from about 20% to about 60%, and more preferably from about 30% to about 55%.

The “end-capping agent” in the present invention refers to a polyester compound which contains per molecule at least 6 carbon atoms, a hydrophobic end portion, at least one —COO— (ester) group and one —OH (hydroxyl) group. The end-capping agent itself may be hydrophobic or hydrophilic, according to the HLB (Hydrophile-Lipophile Balance) scale.

The end-capping agent of the present invention can be obtained by reacting a lactone compound with a monohydroxy compound of formula (I) via ring opening polymerization, as described in US Pat. No. 4,647,647.

The term “lactone” refers to a cyclic ester which is the condensation product of an alcohol group and a carboxylic acid group in the same molecule. Suitable lactone compounds used for the present invention may be selected from a group consisting of propiolactone, butyrolactone, valerolactone, caprolactone, and substituted derivatives thereof.

Examples of suitable lactone compounds for the present invention include, but not limited to, β-butyrolactone, γ-butyrolactone, α-Methyl- γ-butyrolactone, δ-valerolactone, ε-caprolactone, γ-phenyl-ε-caprolactone, γ-Heptalactone, γ-Hexalactone, δ-Octalactone, and γ-Octalactone, with their chemical structures as listed below. A particularly preferred example is ε-caprolactone.

| Lactone Examples | Structure |
|---|---|
| β-butyrolactone | 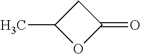 |
| γ-butyrolactone | 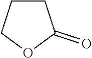 |
| α-Methyl- γ- butyrolactone | 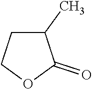 |
| δ-valerolactone | 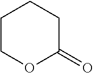 |
| ϵ-caprolactone | 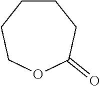 |
| γ-phenyl- ϵ- caprolactone | 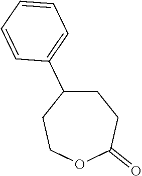 [SMILES: O=C1CCC(c2ccccc2)CCO1] |
| γ-Caprolactone | 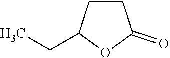 |
| γ-Heptalactone | 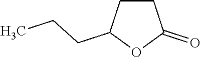 |
| γ-Hexalactone | 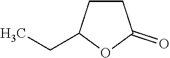 |
| Octalactone | 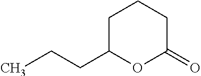 |
| γ-Octalactone | 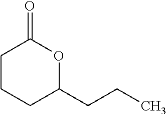 |
| | 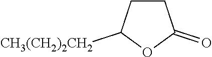 |

Monohydroxy compounds of formula (I) employed in the present invention to prepare the end-capping agent include aliphatic, cycloaliphatic or aromatic compounds, each can be linear or branched, saturated or unsaturated, and preferably saturated.

Monohydroxy compounds of formula (I) can be primary alcohol, secondary alcohol or tertiary alcohol, and preferably primary alcohol.

In one preferred embodiment of the present invention, X is a substituted or unsubstituted alkyl group having 5 to 40 carbon atoms, preferably 6 to 20 carbon atoms, and more preferably 10 to 14 carbon atoms. In another preferred embodiment of the present invention, X is a substituted or unsubstituted cycloalkyl group having 6 to 40 carbon atoms, preferably 10 to 35 carbon atoms, and more preferably 15 to 25 carbon atoms.

Suitable examples of aliphatic monohydroxy compounds of formula (I) include, but not limited to, n-butanol, n-octanol, n-nonanol, n-decanol, n-docecanol, n-tetradecanol, n-hexadecanol, n-octadecanol, 2-ethyl-hexanol, 2-bytyl-1-octanol, isodecanol, isotridecanol, 2-cyclohexylethanol, 4-cyclohexyl-l-butanol, 4-phenyl-1-butanol, 5-phenyl-1-pentanol, and 8-phenyl-1-octanol, each may be used alone or in combination. In one preferred example for the invention, the aliphatic monohydroxy compound(s) of formula (I) is one or more selected from the group consisting of n-decanol, n-docecanol, and n-tetradecanol.

In yet another preferred embodiment of the present invention, X is a substituted or unsubstituted aromatic group having at least 6 carbon atoms. Particularly, X may be a polyalkyleneoxy moiety with repeating units of EO, making the monohydroxy compounds of formula (I) an ethoxylate. Preferably, the monohydroxy compounds of formula (I) is an alkaryl ethoxylate, such as tristyrylphenol ethoxylates. Commercially available products of tristyrylphenol ethoxylates suitable for the present invention include Emulsogen® TS products from Clariant, e.g. ethoxylated tristyrylphenol with 10 EO (Emulsogen® TS 100), with 16 EO (Emulsogen® TS 160), with 20 EO (Emulsogen® TS 200), with 29 EO (Emulsogen® TS 290), with 40 EO (Emulsogen® TS 400), with 54 EO (Emulsogen® TS 540) and with 60 EO (Emulsogen® TS 600). Among the above listed products, Emulsogen® TS 200 (ethoxylated tristyrylphenol with 20 EO) is found to be particularly preferred.

The lactone ring-opening polymerization reaction with monohydroxy compounds of formula (I) is carried out by known methods, usually at temperatures of about 100° C. to 180° C., and preferably initiated by catalyst such as p-toluenesulphonic acid or dibutyl tin dilaurate.

In a second aspect, the present invention provides an end-capping agent for preparing a hydrophobically modified alkylene oxide polyurethane, wherein the end-capping agent is a polyester obtained by reacting a lactone compound with a monohydroxy compound of formula (I) via the lactone ring-opening polymerization reaction

X—OH (I)

wherein X is as defined above.

In a third aspect, the present invention provides an end-capping agent for preparing a hydrophobically modified alkylene oxide polyurethane, which is a polyester having the structure of formula (II)

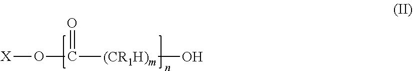

wherein X is as defined above, each R₁ is independently H or C1-C4 alkyl, m is an integer from 2 to 7, preferably 3 to 5, and n is an integer from 1 to 10, preferably 4 to 8.

In one embodiment of the present invention, the hydrophobically modified alkylene oxide polyurethane is obtainable by: first mixing an end-capping agent as aforementioned and a water-soluble polyalkylene glycol, heating the mixture, preferably at a temperature in the range of 50° C. to 110° C.; then adding a diisocyanate in an amount of 0 to 35 percent (preferably from 5 to 35 percent) stoichiometric excess with respect to the isocyanate reactive groups of the polyalkylene glycol and the end-capping agent, optionally with a urethane promoting catalyst, e.g. bismuth octoate. Upon completion of this reaction, sufficient water is added to the product mixture to quench excess isocyanate groups from the polyurethane product and forming an aqueous polymer solution.

In another embodiment of the present invention, the hydrophobically modified alkylene oxide polyurethane is obtainable by: first contacting a water-soluble polyalkylene glycol and a diisocyanate under reaction conditions to form a prepolymer, then contacting an end-capping agent as aforementioned with the prepolymer under reaction conditions to form the desired polyurethane. Preferably, upon completion of this reaction, sufficient water is added to the product mixture to quench excess isocyanate groups from the polyurethane product and forming an aqueous polymer solution.

In a fourth aspect, the present invention provides a hydrophobically modified alkylene oxide polyurethane having the structure of formula (III), which can be obtained by the reactions between the end-capping agent, water-soluble polyalkylene glycol and diisocyanate as aforementioned,

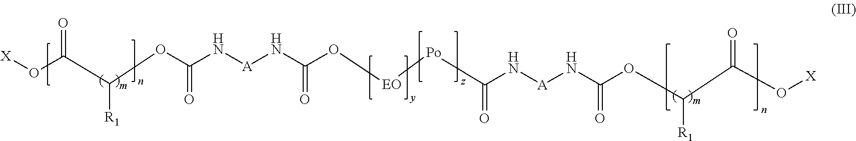

wherein X, R₁, m, n, A, EO, PO, x and y are as defined above.

Furthermore, the present invention also provides a thickener composition comprising an aqueous solution of a hydrophobically modified alkylene oxide polyurethane having the structure of formula (III). For example, said aqueous solution may be formed by contacting a polyurethane of formula (III) with water at an elevated temperature.

The present invention also relates to the use of a thickener composition according to the invention in aqueous dispersions, such as automotive and industrial paints, pigment printing pastes, cosmetic formulations, waterborne adhesive formulations, cleaning compositions, waterborne coating compositions, and printing and textile inks.

### EXAMPLES

The following examples are for illustrative purposes only and not intended to limit the scope of the invention.

HEUR Production

### Example 1

(1-a) Preparation of End-Capping Agent from Alkyl Alcohols

14.6 g ε-caprolactone (from Sinopharm chemical reagent company) and 25 g of a C12-14 alcohol blend comprised of decanol (<1.5%), dodecanol (c. 70%), tetradecanol (c. 27%), and hexadecanol (<1.5%) (Nafol® 1214 S from Sasol) were added into a 100m1 reaction flask and the reactants were heated to 120° C.

When the mixture was completely melted, 0.40 g dibutyl tin dilaurate (DBTDL, from Sinopharm chemical reagent company) was added as catalyst to the flask. The reaction mixture was continuously heated and stirred at 120° C. for 6 hours, and then stepwise cooled down to room temperature, until a solid polyester product with an average molecular weight of 320 g/mol (determined from OH number) is obtained.

(1-b) Preparation of HEUR

4.14 g (12.94 mmol) of the polyester obtained in (1-a) and 81.47 g (10.35 mmol) Polyglykol 8000 S (from Clariant) were added into a 500 ml four-necked bottle reactor equipped with a condenser. The loaded reactor was placed on a heat block adjusted to 120° C. and a 20 mbar vacuum was applied in the reactor continuously for 2 hours to remove water. After cooling the reactor content to 70° C. with nitrogen influx, 4.41 g 4,4′-methylenebis(isocyanatocyclohexan) (H₁₂-MDI, from Wanhua) (16.82 mmol) was added into the reactor and the reaction was continued for 2 hours at 95° C. Subsequently, the reactor content was cooled to 70° C. and 210 g of deionized water was dropwise added to the reactor under stirring, until the HEUR polymer was completely dissolved and forms a homogenous, white turbid solution with a viscous appearance.

### Example 2

(2-a) Preparation of End-Capping Agent from Alkyl Alcohols

A polyester was prepared in the same manner as example (1-a), except that 8.0 g of Nafol® 1214 S and 22.8 g of ε-caprolactone were used and the amount of DBTDL was adjusted to 0.32 g in the reactant mixture. A solid polyester product with an average molecular weight of 682 g/mol (determined from OH number) is obtained.

(2-b) Preparation of HEUR

HEUR of (2-b) was prepared in the same manner as example (1-b), except that 8.34 g of polyester obtained in (2-a) was used as starting material, and the amounts of H₁₂-MDI and Polyglykol 8000 S were adjusted to 4.19 and 77.46 g.

### Example 3

(3-a) Preparation of End-Capping Agent from Alkyl Alcohols

A polyester was prepared in the same manner as example (1-a), except that 5.0 g of Nafol® 1214 S and 28.5 g of ε-caprolactone were used and DBTDL was replaced by 335 mg of TIB KAT 256 (Monobutyltin oxide purchased from TIBCHEMICALS) in the reactant mixture. A solid polyester product with an average molecular weight of 1082 g/mol (determined from OH number) is obtained.

(3-b) Preparation of HEUR

HEUR of (3-b) was prepared in the same manner as example (1-b), except that 4.14 g of polyester obtained in (3-a) was used as starting material, and the amounts of H₁₂-MDI and Polyglykol 8000 S were adjusted to 4.41 g and 81.47 g.

### Example 4

(4-a) Preparation of End-Capping Agent from Aromatic Alcohols

3.3 g ε-caprolactone and 32 g of Emulsogen® TS200 (from Clariant) were added into a 100m1 reaction flask and the reactants was heated to 120° C. When the mixture was completely melted, 353mg DBTDL was added as catalyst to the flask. The reaction mixture was continuously heated and stirred at 120° C. for 6 hours, and then stepwise cooled down to room temperature, until a solid polyester product with an average molecular weight of 1301 g/mol (determined from OH number) is obtained.

(4-b) Preparation of HEUR

14.68 g (11.3 mmol) of the polyester obtained in (4-a) and 71.46 g (9.08 mmol) Polyglykol 8000 S (from Clariant) were added into a 500 ml four-necked bottle reactor equipped with a condenser. The loaded reactor was placed on a heat block adjusted to 130° C. and a 20 mbar vacuum was applied in the reactor continuously for 2 hours to remove water. After cooling the reactor content to 80° C. with nitrogen influx, 3.86 g H₁₂-MDI (from Wanhua, 14.72 mmol) was added into the reactor and the reaction was continued for 2 hours with heating block set at 105° C. Subsequently, the reactor content was cooled to 70° C. and 210 g of deionized water was dropwise added to the reactor under stirring, until the HEUR polymer was completely dissolved and forms a homogenous, white turbid solution with a viscous appearance.

### Example 5

(5-a) Preparation of End-Capping Agent from Aromatic Alcohols

A polyester was prepared in the same manner as example (4-a), except that 11.9 g of ε-caprolactone and 23.0 g of Emulsogen® TS200 were used and the amount of DBTDL was adjusted to 349 mg in the reactant mixture. A solid polyester product with an average molecular weight of 1563 g/mol (determined from OH number) is obtained.

(5-b) Preparation of HEUR

HEUR of (5-b) was prepared in the same manner as example (4-b), except that 17.08 g (10.93 mmol) of polyester obtained in (5-a) was used as starting material, and the amounts of H₁₂-MDI and Polyglykol 8000 S were adjusted to 3.74 g (14.26 mmol) and 69.23 g (8.80 mmol).

### EXAMPLE OF PRACTICAL APPLICATION

The HEUR thickeners in Examples of the present invention were evaluated for thickening effects in styrene-acrylate copolymer latex, acrylate homopolymer latex and VAE latex formulations. BR100P (a water soluble non-ionic polyurethane thickener product from COATEX) was used as benchmark.

The commercial latex products used in the following application examples include:

Latex A: MAINCOTE™ HG-54C, a styrene-acrylate copolymer latex (from Dow) with a solid content of 42.05% by weight;

Latex B: DA-102, a copolymer dispersion based on vinyl acetate and ethylene (from Dairen Chemical Corp.) with a solid content of 55.02% by weight;

Latex C: SETAQUA® 6998, an acrylic top coat emulsion resin (from Allnex) with a solid content of 37.82% by weight;

Latex D: Mowilith® LDM71, an acrylic latex for waterborne coating (from Archroma) with a solid content of 46.78% by weight; and

Latex E: Mowilith® DN 7070, a crosslinked acrylic latex for waterborne coating (from Archroma) with a solid content of 44.17% by weight.

Procedure of Evaluating Thickening Effects

A diluted latex dispersion with 35% solid content is prepared by mixing distilled water and one commercial latex product mentioned above. A homogeneous water solution containing 3% polyurethane thickener by weight was then prepared, and subsequently weighed to be partly added into said diluted latex dispersion, based on a certain dry weight percentage (0.39% or 1.13%, referred as “DWP” in the Tables below). The thickener is dispersed into the latex solution by stirring at 1000 rpm for 5 minutes with the help of dispersion and milling equipment JSF-550, at room temperature, to homogenize it. The viscosity of each latex — thickener mixture is then measured using HAAKE Rheometer RS61 at a shear rate of 1 s⁻¹ or 5 s⁻¹.

Testing results of aliphatic HEUR of Example 1 were compared with BR100P in Table 1.

TABLE 1

| | | DWP | Viscosity (cps) | Viscosity (cps) |
|---|---|---|---|---|
| Latex Type | Polyurethane | (%) | at 1 s⁻¹ | at 5 s⁻¹ |
| Latex A | BR100P | 0.39 | 125.2 | 111.6 |
| | Example 1 | 0.39 | 1.356E+4 | 3763 |
| Latex B | BR100P | 1.13 | 25.71 | 19.89 |
| | Example 1 | 1.13 | 39.68 | 27.92 |
| Latex C | BR100P | 0.39 | 829.6 | 774.3 |
| | Example 1 | 0.39 | 2.063E+4 | 5281 |
| Latex D | BR100P | 0.39 | 1847 | 1545 |
| | Example 1 | 0.39 | 6417 | 3783 |
| Latex E | BR100P | 0.39 | 240.1 | 198.8 |
| | Example 1 | 0.39 | 9869 | 3499 |

Testing results of aromatic HEUR of Example 4 were compared with BR100P in Table 2.

TABLE 2

| | | DWP | Viscosity (cps) |
|---|---|---|---|
| Latex Type | Polyurethane | (%) | at 1 s⁻¹ |
| Latex A | BR100P | 0.39 | 125.2 |
| | Example 4 | 0.39 | 223.3 |
| Latex B | BR100P | 1.13 | 25.71 |
| | Example 4 | 1.13 | 123.8 |

The results show that the HEURs of the present invention are not only able of providing high thickening effect in waterborne latex coating formulations, they also exhibit excellent compatibility with various latex resins used in coating industry, both features being an improvement of some commercial products.

Finally, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A thickener composition comprising a polyurethane polymer obtained by reacting
(a) an end-capping agent obtained by reacting a lactone compound with a monohydroxy compound of formula (I)
X—OH (I)
wherein X is an aliphatic, cycloaliphatic or aromatic hydrocarbon group having at least 5 carbon atoms and optionally containing at least one —O— or —COO— group;
(b) a water-soluble polyalkylene glycol, and (c) a diisocyanate.

2. The thickener composition of claim 1, wherein the monohydroxy compound of formula (I) is selected from a group consisting of n-butanol, n-octanol, n-nonanol, n-decanol, n-docecanol, n-tetradecanol, n-hexadecanol, n-octadecanol, 2-ethyl-hexanol, 2-bytyl-1-octanol, isodecanol, isotridecanol, 2-cyclohexylethanol, 4-cyclohexyl-1-butanol, 4-phenyl-1-butanol, 5-phenyl-1-pentanol, and 8-phenyl-1-octanol.

3. The thickener composition of claim 1, wherein the monohydroxy compound of formula (I) is selected from a group consisting of n-decanol, n-docecanol, and n-tetradecanol.

4. The thickener composition of claim 1, wherein the monohydroxy compound of formula (I) is an alkaryl ethoxylate.

5. The thickener composition of claim 1, wherein the monohydroxy compound of formula (I) is ethoxylated tristyrylphenol with 20 repeating units of EO.

6. The thickener composition of claim 1, wherein the water-soluble polyalkylene glycol has a number average molecular weight (Mn) of 1,500 to 50,000.

7. The thickener composition of claim 1, wherein the diisocyanate is selected from the group consisting of 1,6-hexamethylene diisocyanate (HDI), isophorone diisocyanate (IPDI) and 4,4′-methylenebis(isocyanatocyclohexane) (H₁₂-MDI).

8. The thickener composition of claim 1, wherein the polyurethane polymer is obtained by: first mixing the end-capping agent and the water-soluble polyalkylene glycol, heating the mixture; then adding the diisocyanate in an amount of 0 to 35 percent stoichiometric excess with respect to the isocyanate reactive groups of the polyalkylene glycol and the end-capping agent to form the polyurethane.

9. The thickener composition of claim 1, wherein the polyurethane polymer is obtained by: first contacting the water-soluble polyalkylene glycol and the diisocyanate under reaction conditions to form a prepolymer, then contacting the end-capping agent with the prepolymer under reaction conditions to form the polyurethane.

10. An end-capping agent for preparing a hydrophobically modified alkylene oxide polyurethane, wherein the end-capping agent is a polyester obtained by reacting a lactone compound with a monohydroxy compound of formula (I) via a lactone ring-opening polymerization reaction
X—OH (I)
wherein X is an aliphatic, cycloaliphatic or aromatic hydrocarbon group having at least 5 carbon atoms and optionally containing at least one —O— or —COO— group, and wherein the lactone compound is selected from a group consisting of propiolactone, butyrolactone, valerolactone, caprolactone, and substituted derivatives thereof.

11. An end-capping agent for preparing a hydrophobically modified alkylene oxide polyurethane, wherein the end-capping agent is a polyester having the structure of formula (II) 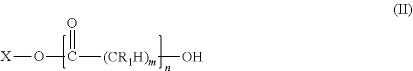
wherein X is an aliphatic, cycloaliphatic or aromatic hydrocarbon group having at least 5 carbon atoms and optionally containing at least one —O— or —COO— group and R₁ is a H or C₁-C₄ alkyl.

12. A hydrophobically modified alkylene oxide polyurethane having the structure of formula (III) 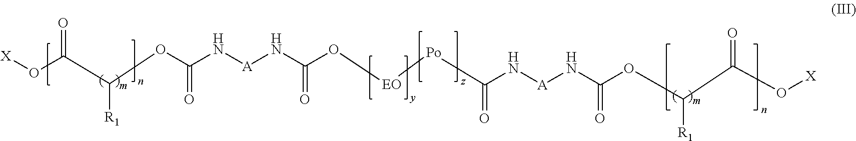
wherein X is an aliphatic, cycloaliphatic or aromatic hydrocarbon group having at least 5 carbon atoms and optionally containing at least one —O— or —COO— group, each R₁ is independently H or C₁-C4 alkyl, m is an integer from 2 to 7, n is an integer from 1 to 10, EO represents an ethylene oxide unit, PO represents a propylene oxide unit, y is an integer from 40 to 250, z is an integer from 0 to 95 and less than y, and A represents a straight-chain or branched alkylene, arylene or aralkylene radical with 4 to 15 carbon atoms, each optionally substituted with one or more C₁ to C₄ alkyl group and/or one or more halogen atoms.

13. A thickener composition comprising an aqueous solution of the hydrophobically modified alkylene oxide polyurethane of claim 12.

14. A waterborne coating composition comprising a thickener composition according to claim 1.

15. A waterborne adhesive formulation comprising a thickener composition according to claim 1.

16. The thickener composition of claim 1, wherein the monohydroxy compound of formula (I) is a tristyrylphenol ethoxylate.

17. The thickener composition of claim 1, wherein the water-soluble polyalkylene glycol has a number average molecular weight (Mn) of 3,000 to 20,000 g/mol.

18. The thickener composition of claim 1, wherein the water-soluble polyalkylene glycol has a number average molecular weight (Mn) of 4,000 to 10,000 g/mol.
